(19) United States
(12) Patent Application Publication
(10) Pub. No.: US 2024/0212880 A1
(43) Pub. Date: Jun. 27, 2024

(54) FLEXIBLE FLAT WIRE CABLE WITH HIGH FREQUENCY CONDUCTORS

(71) Applicant: Aptiv Technologies AG, Schaffhausen (CH)

(72) Inventors: Richard J. Boyer, Mantua, OH (US); John F. Heffron, Youngstown, OH (US); Jared Bilas, North Bloomfield, OH (US)

(21) Appl. No.: 18/536,964

(22) Filed: Dec. 12, 2023

Related U.S. Application Data
(60) Provisional application No. 63/434,750, filed on Dec. 22, 2022.

(51) Int. Cl. H01B 7/17; H01B 7/40

(52) U.S. Cl. CPC H01B 7/17; H01B 7/40

(57) ABSTRACT

A wiring cable and a method of manufacturing a wiring cable are described. The wiring cable includes a plurality of elongate planar electrical conductors electrically insulated from one another and shielded by a protective jacket formed over the elongate electrical conductors. The protective jacket includes a substantially flat outer surface of the wiring cable. The wiring cable further includes a signal conductor with an annular outer profile integrated with the protective jacket at the substantially flat outer surface and at least partially shielded from interference by the protective jacket of the wiring cable. The annular signal conductor may be jacketless, without annular shielding or an annular protective coating.

### CROSS-REFERENCE TO RELATED APPLICATIONS

This application claims the benefit of and priority to U.S. provisional application 63/434,750, titled “Flexible Flat Wire Cable with High Frequency Conductors”, filed Dec. 22, 2022, the entire contents of which are incorporated by reference herein.

### TECHNICAL FIELD

This application relates generally to wiring, and more specifically to advancements in wiring for vehicular applications.

### BACKGROUND

Wiring harnesses for automotive and other vehicular applications traditionally employed rounded cabling to carry electrical signals and/or power signals as part of a vehicle electrical and communications system. Some rounded electrical cables that carry high-speed data signals (e.g., coaxial cables, twisted pair cables, ethernet cables), require shielding and plastic coating to protect the conductor from damage, including from overbending. In some examples, shielding and jacketing may make up a substantial part of the cost and complexity to manufacture quality high-speed data cables that offer desirable performance.

Recently, bendable flat cabling, which may be referred to as a flex circuit, flat flexible cable (FFC), and flexible printed cable (FPC) has been viewed as a potential replacement for round cabling in some vehicle applications due to an ability to carry a high density of electrical conductors in a small space over relatively long distances. In some examples, flat cabling may also be particularly suitable to manipulation by human or robotic actuators, which may enable robotic wiring harness installation in a vehicle.

Modern vehicles incorporate more and more features and functions that rely on high-speed data transfer. A need therefore exists for improvements in cabling designs to practically accommodate high-speed data transfer as part of a vehicular electrical and communications system.

### SUMMARY

This disclosure is directed to improvements in wiring cables, including flat wiring cables with one or more integrated annular signal conductor. For example, a wiring cable is described herein. The wiring cable includes a plurality of elongate planar electrical conductors electrically insulated from one another and shielded by a protective jacket formed over the elongate electrical conductors. The protective jacket includes a substantially flat outer surface of the wiring cable. The wiring cable further includes a signal conductor with an annular outer profile that is integrated with the protective jacket at the substantially flat outer surface and at least partially shielded from interference by the protective jacket of the wiring cable. In some examples, the signal conductor includes an annular outer surface of a dielectric layer that surrounds an annular conductor. In some examples, the protective jacket wraps around the annular outer profile of the signal conductor at an edge of the wiring cable, and substantially surrounds and shields the signal conductor. In some examples, a first portion of the signal conductor is shielded by the shielding layer of the protective jacket, and wherein a second portion of the signal conductor is shielded by shielding structure integrated with the protective jacket.

According to another example, a method of forming a wiring cable is described. The method includes forming a plurality of elongate planar electrical conductors electrically insulated from one another. The method further includes forming a protective jacket over the plurality elongate planar electrical conductors wherein the protective jacket includes a substantially flat outer surface of the wiring cable. The method further includes integrating a signal conductor with an annular outer profile with the substantially flat outer surface of the protective jacket. The protective jacket at least partially shields the signal conductor from interference. In some examples, integrating the signal conductor with the outer profile of the signal conductor at an edge of the wiring cable to substantially surround and shield the signal conductor. In some examples, integrating the signal conductor with the protective jacket includes shielding a first portion of the signal conductor with a shielding layer of the protective jacket, and shielding a second portion of the signal conductor with a shielding structure integrated with the protective jacket.

### BRIEF DESCRIPTION OF THE DRAWINGS

FIG. 1A is an isometric view of a wiring cable according to some embodiments.

FIG. 1B is a side view of a wiring cable according to some embodiments.

FIG. 2 is a diagram depicting a cross-sectional view of one example of a wiring cable according to some embodiments.

FIG. 3 is an isometric view of a wiring cable with an annular signal conductor integrated with the wiring cable according to some embodiments.

FIG. 4 is an isometric view of a wiring cable with an annular signal conductor integrated with the wiring cable according to some embodiments.

FIG. 5 is an isometric view of a wiring cable with multiple annular signal conductors integrated with the wiring cable according to some embodiments.

FIG. 6 is an isometric view of a wiring cable with multiple annular signal conductors integrated with the wiring cable according to some embodiments.

FIG. 7 is an isometric view of a wiring cable with four annular signal conductors integrated with the wiring cable according to some embodiments.

FIG. 8 is a side view of a wiring cable with four annular signal conductors integrated with the wiring cable according to some embodiments.

FIG. 9 is a flow diagram that depicts an example of a method of forming a wiring cable according to some embodiments.

### DETAILED DESCRIPTION

High-speed data cables are often used to carry data at high speeds as part of a communications system, such as the communications system of a vehicle. Examples of high-speed data cables include coaxial cables and twisted pair (e.g., ethernet) cables. As an example, a traditional high speed coaxial cable includes a conductive center core (e.g., an annular copper wire), surrounded by a dielectric insulator. As another example, a twisted pair cable includes a twisted wire pair as a center core, similarly surrounded by an annular dielectric insulator. According to both examples, the dielectric insulator separates the center core from metallic shielding that protects the center core from electromagnetic interference, and external plastic coating is formed over the dielectric insulator to protect and stiffen the cable.

In some examples, forming the metallic shielding and external coating make up a substantial part of the Bill of Materials (BOM) cost to manufacture high-speed data cables. The quality, thickness, and stiffness of the external coating and metallic shielding used in a high-speed data cable may have a significant impact on cable performance and longevity.

In traditional automotive vehicles, wiring harnesses including bundles of round cables were commonly used to implement electrical and communication systems in vehicles. Bendable flat cabling, also referred to as “Flex Circuit” technology, has been considered as a replacement for traditional wiring harnesses. Flat cabling as described herein may include a plurality of elongate conductors with a substantially rectangular cross-section and are covered by a common protective jacket that includes shielding to protect the conductors from electromagnetic interference. Wiring harnesses employing flat cabling may offer advantages over round cable bundles used in traditional wiring harnesses. For example, flat cabling may carry electrical conductors with greater density than round cable counterparts. In addition, flat cabling may be relatively easy to manipulate, by a human or robotic operator, as part of vehicle manufacturing processes.

This disclosure is directed to improvements in automotive cabling solutions in which a flat wiring cable is provided that includes an integrated annular signal conductor. The integrated annular signal conductor is surrounded by a dielectric layer with an annular outer profile. The annular signal conductor may be considered “jacketless” in that it includes a core conductor or conductors surrounded by a dielectric layer with an annular outer surface, but does not include electromagnetic shielding or external plastic coating as used in traditional coaxial cables.

Instead of the annular signal conductor itself including shielding or an external plastic coating, at least a portion of the annular signal conductor is shielded by a protective jacket of the flat cabling, which itself includes a shielding layer. In some examples, the signal conductor is arranged on a surface of the protective jacket near an elongated edge of the flat cabling, and a section or sections of the flat cabling are wrapped around the signal conductor to form a channel such that the protective jacket shields the annular signal conductor from electromagnetic interference. The flat cabling exterior surface in contact with the outer surface of the dielectric layer of the annular signal conductor may further secure the annular signal conductor in place, integrated to with the flat cabling.

In other examples, the annular signal conductor is arranged on a surface of the protective jacket that shields a first portion of the signal conductor, and a shielding structure is arranged over the annular signal conductor integrated with the protective jacket that shields a second, different portions of the annular signal conductor. The shielding structure also secures the annular signal conductor to the protective jacket integrated with the flat cabling.

Wiring cables including flat cabling with one or more integrated annular signal conductor as described herein may offer benefits in comparison to known cable solutions. For example, integrating the annular signal conductor may enable a vehicle wiring harness with the conductor density advantages associated with flat cabling, but with high performance high-speed data transfer functionality offered by round cable implementations, like coaxial or twisted-pair data cables. In some examples, wiring cables as described herein may enable flat conductors carrying low speed signal, data, and power signals to be integrated with high-speed data cables in a single step, which may be less expensive and/or complex to implement in comparison to independently manufacturing and installing each component separately. In some examples, because the flat cabling provides structural rigidity to the integrated annular conductor, less expensive and/or complex processes may be used to shield the annular signal conductor than are used for traditional high-speed data cabling. For example, in embodiments where an additional shielding structure is used to shield the annular signal cable, less expensive and/or lower quality materials may be used in comparison to those used to protect and shield traditional high-speed data cables. In some examples, wiring cables as described herein may be easily manipulable by a human or robotic operator to install a wiring harness built using the wiring cable in a vehicle.

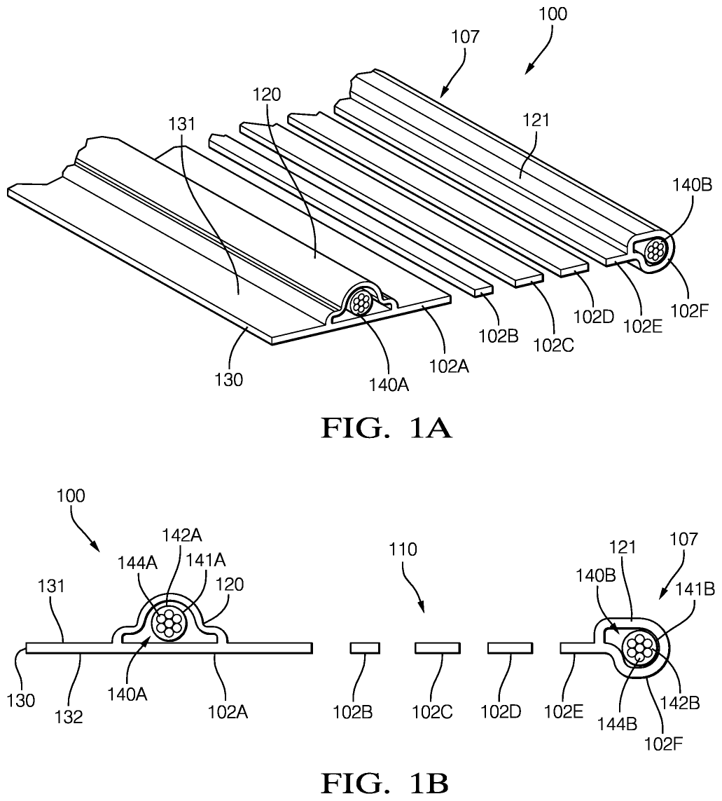

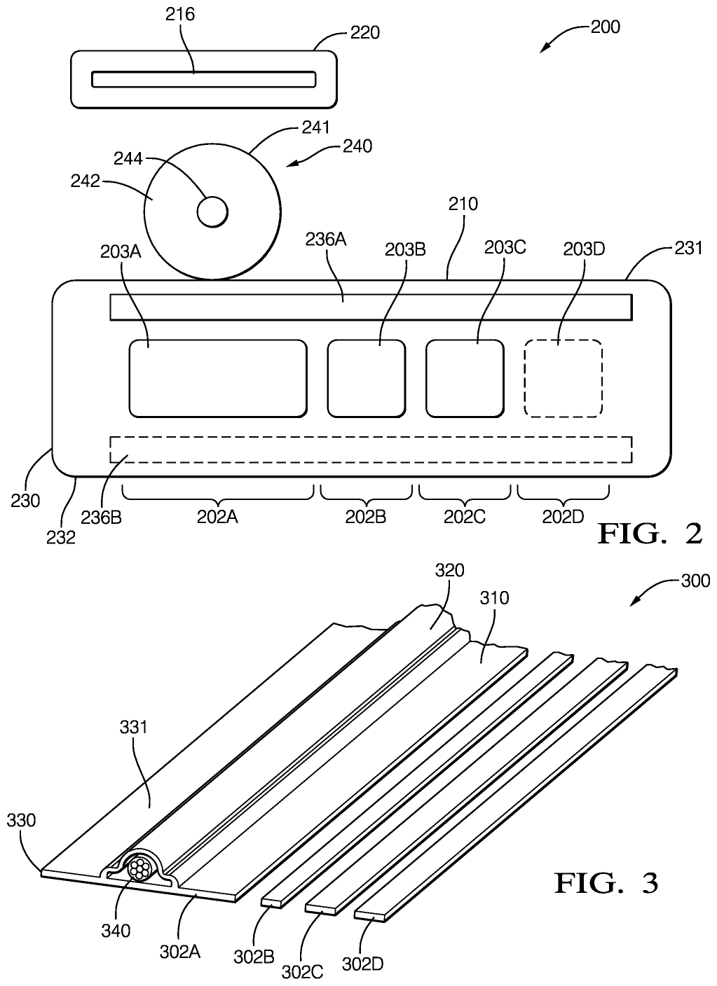

FIG. 1A is a perspective diagram showing one example of a flat wiring cable 100 according to some embodiments. FIG. 1B is a side-view of a flat wiring cable 100 according to some embodiments. FIG. 2 is a cross-sectional of a flat wiring cable 200 according to some embodiments.

As shown in FIGS. 1A and 1B, wiring cable 100 includes a plurality of elongate wire sections 102A-102F, at least some of which carry elongate electrical conductors with a rectangular cross-section that collectively present a flat exterior profile of the wiring cable 100. Wiring cable 100 may be referred to as a flex circuit, flat flexible cable (FFC), and flexible printed cable (FPC). For purposes of explanation, the respective wiring sections 102A-102F of FIGS. 1A and 1B are shown separated from one another for purposes of illustration. In practice, wiring sections 102A-102F are not separated. Instead, wiring sections 102A-102F are arranged adjacent to and electrically insulated from one another, surrounded by a common protective jacket 130 with a first planar surface 131 above the elongate conductors, and a second planar surface 132 below the elongate conductors.

FIG. 2 is a diagram illustrating a cross-sectional view of a flat wiring cable 200 according to some embodiments. The flat wiring cable 200 includes a plurality of cable sections 202A-202D, four in the example of FIG. 2. Cable sections 202A-202D correspond to elongate conductors 203A-203D of the flat wiring cable 200. As shown by the dashed lines surrounding conductor 203D, some of sections 202A-202D may not carry a conductor.

As shown in the example of FIG. 2, each of the elongate conductors 203A-203D has a rectangular or square shaped cross-section, and are arranged adjacent to another surrounded by a common protective jacket 230 that supports each of conductors 203A-203D together and presents a substantially flat first planar surface 231 and a substantially flat second planar surface 232. In some examples, the first planar surface 231 of the protective jacket 230 is an outer surface 210 of wiring cable 100 across the flat surfaces of conductors 203A-203D.

In some examples, each of conductors 203A-203D are configured to carry distributed electrical signals as part of a vehicle electrical and/or communications system. For example, conductor 203A may carry a ground connection, and conductor 203B may carry an electrical signal associated with one or more vehicle systems. Other conductors 203C, 203D of the wiring cable 200 may carry other signals associated with vehicle systems, or may carry electrical power. In some examples, a width of each conductor 203A-203D is substantially uniform. In other examples, a width of some conductors 203A-203D may differ. For example, section 202A includes a wider conductor 203A, which may carry a ground or power, while other sections 202B-202D carry narrower conductors used to carry signals or for other applications.

As also shown in FIG. 2, protective jacket 230 includes shielding 236A, and optionally shielding 236B, to protect the conductors 203A-203D from electromagnetic interference. Shielding 236A may be a conductive layer, such as a metallic mesh, arranged above conductors 203A-203D to protect them from electromagnetic interference. In some examples, protective jacket 230 also includes shielding 236B below conductors 203A-203D to shield conductors 203A-203D from underneath. In still other examples not depicted, protective jacket 230 includes continuous shielding that surrounds conductors 203A-203D on all sides.

In some examples, wiring cable 200 is formed by arranging conductors 203A-203D together, and forming protective jacket 230 around the conductors, including shielding 236A. For example, protective jacket 230 may be formed by extruding a plastic or plastic-like polymer over the conductors 203A-203D to substantially surround the conductors and form the protective jacket. In other examples, one or more laminates may be heated and cured to form the protective jacket 230.

As shown in FIG. 2, an annular signal conductor 240 is arranged on the wiring cable 200, at outer surface 210. Annular signal conductor 240 is analogous to annular signal conductors 140A and 140B depicted in FIGS. 1A and 1B, and includes a dielectric layer 242 that surrounds a core conductor 244. As shown in FIG. 2, like both the annular signal conductors 140A, 140B depicted in FIGS. 1A and 1B, the outer surface 210 of wiring cable 200 is arranged in contact with the outer surface 241 of the dielectric layer 242 of the annular signal conductor 240. In some embodiments, the annular signal conductor 240 is secured to the outer surface 210 with a shielding structure 220, as shown in FIG. 2.

Referring back to FIGS. 1A-1B, wiring cable 100 includes annular signal conductors 140A and 140B integrated with a substantially flat outer surface 110 of the wiring cable 100 in different ways, according to some embodiments. According to the example of FIGS. 1A and 1B, wiring cable 100 includes an annular signal conductor 140A, integrated with wiring cable 100 via a shielding structure 120 secured to the flat outer surface 110 of the wiring cable 100 (e.g., an upper surface 131 of protective jacket 130). As also shown in FIGS. 1A and 1B, wiring cable 100 further includes a second annular signal conductor 140B integrated with the wiring cable 100 by a portion of the protective jacket 130 wrapped around the annular signal conductor 140B to form a channel 121 that at least partially surrounds the annular signal conductor 140B and secures the annular signal conductor 140B to the protective jacket 130.

Referring now to FIG. 1B, annular signal conductors 140A, 140B each include a core conductor 144A, 144B that includes a plurality of conductive strands wound together to form an electrical signal conductor. In other examples not depicted, annular signal conductors 140A, 140B may not be stranded and instead be formed of a single conductive core wire. In still other examples not depicted, annular signal conductors 140A, 140B may include a plurality of conductive wires electrically insulated from one another in a twisted-pair cable, such as an ethernet cable.

As shown in FIG. 1B, annular signal conductors 140A, 140B includes a dielectric layer 142A that surrounds core conductor 144A, and presents an annular outer surface 141A, 141B. In some examples of traditional high-speed data cables, the dielectric layer 142A, 142B serves to provide separation between the core conductor 144A, 144B and shielding that serves to protect the core conductor 144A, 144B from interference, and an external plastic coating is formed over the shielding and the dielectric layer 142A, 142B. In some examples, a substantial portion of the cost of manufacturing a traditional high-speed data cable is associated with forming the shielding and external plastic coating. In some examples, an annular signal conductors 140A, 140B as described herein are less expensive and/or less complex to manufacture than traditional high-speed data cables.

As shown in FIG. 1B, annular signal conductor 140A is integrated with wiring cable 100 via the flat outer surface 110 of the wiring cable, i.e., a surface 131 of protective jacket 130. As shown, annular signal conductor 140A is arranged on a surface 110 on a section 102A-102D of the wiring cable 100, section 102A in the FIG. 1B example. Section 102A is wider than other sections 102B-102F of the wiring cable 100. In some examples, section 102A is a ground conductor of the wiring cable 100, or other conductor that presents less potential for electromagnetic interference to annular signal conductor 140A, in comparison to other sections to wiring cable 102B-102D, which may carry signal, power, or other conductors more likely to interfere with annular signal conductor 140A. In other examples, annular signal conductor 140A may be arranged on other sections 102B-102E of wiring cable 100 that are relatively wide or narrow. In some examples, annular signal conductor 140 may be arranged on a “dummy” section (not shown) of the wiring cable 100 that includes shielding but does not include any conductor, and instead includes a non-conductive core.

As shown in FIG. 1B, annular signal conductor 140A is arranged on wiring cable 100, on surface 131 of a protective jacket 130 of the wiring cable 100. As arranged, protective jacket 130 (i.e., via shielding 236A depicted in FIG. 2) protects a portion of the annular signal conductor 140A from interference, for example at least the portion of the annular outer surface 141A in contact with the protective jacket 130.

As also shown in FIG. 1B, a shielding structure 120 is formed over the annular signal conductor 140A, arranged on the surface 131 of protective jacket 130. Referring now to the example of FIG. 2, which depicts a shielding structure 220 that includes a shielding layer 216 arranged over an outer surface 241 of the annular signal conductor 240 (i.e., the outer surface 241 not in contact with protective jacket 230), in preparation to be integrated with protective jacket 230 by extrusion, lamination, and/or adhesive tape as described herein and as shown by shielding structure 120 depicted in the example of FIGS. 1A and 1B. As shown in FIGS. 1A-1B, the shielding structure 120 further integrates the signal conductor 140A with the surface 131 of the protective jacket 130, by securing the signal conductor 140A in place on the protective jacket 130.

Shielding structure 120 may be integrated with wiring cable 100, i.e., protective jacket 130, in different ways. For example, shielding structure 120 may be formed over jacket 130 by the same process as was used to form jacket 130, or by a different process. For example, jacket 130 may be formed by extruding a plastic or plastic-like material (including shielding 236A as shown in FIG. 2) over elongate conductors 203A-203D as depicted in the FIG. 2 example in a first step, and then shielding structure 120 (including shielding 216 as depicted in FIG. 2) may be formed by a similar extrusion step over the annular signal conductor 140A arranged on the jacket 130. In other examples, where jacket 130 is formed by heating and curing a laminate, shielding structure 120 may be formed by a similar lamination process. In some examples, jacket 130 and shielding structure 120 may be formed of the same, or compatible materials, such that when heated or otherwise processed, the jacket 130 and shielding structure 120 melt together to form a single unitary structure.

In other examples, different processes may be used to form jacket 130 and shielding structure 120. For example, jacket 130 may be formed by material extrusion, and shielding structure 120 is formed by a laminate or other process. In still other examples, shielding structure 120 may include an adhesive tape that includes a metallic shielding layer 216 and is applied by a human or machine operator over the annular signal conductor disposed on surface 110, to shield the annular signal conductor 140A from interference and integrate it with the wiring cable 100.

In some embodiments, referring to the example of FIG. 2, the shielding layer 216 of the shielding structure 220 and the shielding layer 236A of the protective jacket 230 may be electrically coupled together to improve a resilience of annular signal conductor to interference. For example, one or more vias (not shown) may be formed through the protective jacket 230 to electrically couple the respective shielding layers 216, 236A together.

Referring again to the example of FIGS. 1A and 1B, wiring cable 100 further includes a second annular signal conductor 140B integrated with the wiring cable 100. According to this example, annular signal conductor 140B, which includes an annular outer surface of a dielectric layer 142B that surrounds a core conductor 144B, is arranged on a section 102F of the wiring cable 100 at an elongate edge 107 of the wiring cable 100. As shown in FIG. 1B, section 102F is wrapped around at least part of annular signal conductor 140B, such that protective jacket 130, including a shielding layer 236A of the protective jacket, substantially surrounds the annular signal conductor 140B. In some examples, the section 102F is wrapped around the annular signal conductor 140B such that a surface 131 of the protective jacket 130 is in contact with at least part of the annular outer surface 141B of the annular signal conductor 140B. In some examples, section 102F is wrapped around the annular signal conductor 140B such that a surface 131 if the protective jacket 130 is in contact with a majority of the annular outer surface 141B of the annular signal conductor 140B.

In some examples, section 102F may be specifically designed for the purpose of being bendable as part of a manufacturing process to form a channel to hold annular signal conductor 140B in place and shield the annular signal conductor. For example, section 102F may be formed with or without an elongate conductor(s) 203A-203C formed through it, and instead jacket 130 may be formed around a “dummy” structure, i.e., a malleable plastic or other structure, conducive to being folded over and/or around, annular signal conductor 140B. In other examples section 102F may carry one or more conductors, malleable enough to be folded over wrapped around annular signal conductor 140B

Annular signal conductor 140B may be integrated with wiring cable 100 in a number of ways. For example, annular signal conductor 140B may be arranged at the elongate edge 107 of the wiring cable 100, and section 102F may be folded over it and secured with clips, bolts, tracks, or other mechanism to keep section 102 in place surrounding annular signal conductor 140B. In other examples, section 102F may be heated and folded over annular signal conductor 140B in a malleable state, and cured to form a channel that surrounds annular signal conductor 140B, as part of a process to form protective jacket 130 or another subsequent process.

A wiring cable 100 as described herein, which includes one or more annular signal conductors 140A, 140B integrated with the wiring cable 100 may offer significant advantages over other wiring cables. For example, wiring cable 100 may advantageously support flat, flexible cabling that supports a dense arrangement of electrical conductors used for relatively low speed communications or other electrical applications such as power distribution. At the same time, wiring cable 100 may advantageously support high performance transmission of data at high-speeds. In some examples, wiring cable 100 may advantageously provide high performance, high-speed data transmission functionality with substantially reduced cost and complexity in comparison with traditional annular signal conductors. In some examples, a vehicle wiring harness that includes an integrated annular signal conductor 140A, 140B as described herein may be easier for a human or robotic operator to manipulate and install in a vehicle in comparison to other wiring harnesses that support high-speed data transfer.

FIGS. 3-8 depict various flat wiring cables that include one or more integrated annular signal conductors in some embodiments. FIG. 3 depicts one such example of a wiring cable 300 that includes a plurality of elongate sections 302A-302D that are encased in a common protective jacket 320 with a planar surface 331 that serves as a flat outer surface 310 of the wiring cable 300. In some examples, sections 302A-302D each may carry an elongate electrical conductor with a rectangular cross-section, as described above with respect to FIG. 2. In some examples, the protective jacket 320 includes a shielding layer 236A, as also described with respect to FIG. 2

As shown in FIG. 3, a single annular signal conductor 340 is arranged on the flat surface 310 such that the protective jacket 320 shields at least a portion of the annular signal conductor 340. As also shown in FIG. 3, a shielding structure 320, which includes a shielding layer 216 as depicted in FIG. 2, is integrated with the wiring cable 300. Shielding structure 320 is analogous to shielding structure 120 depicted in FIGS. 1A and 1B applied to annular signal conductor 140A, and may be formed by one or more combinations of extrusion, lamination, adhesive tape, or other mechanisms as described above.

Shielding structure 320 is arranged over annular signal conductor 340 and coupled to the surface 310 of the wiring cable 300, such that it at least partially surrounds and shields (e.g., by an embedded shielding layer 236A as depicted in FIG. 2) the annular signal conductor 340 and secures the annular signal conductor 340 in place integrated with the wiring cable 300.

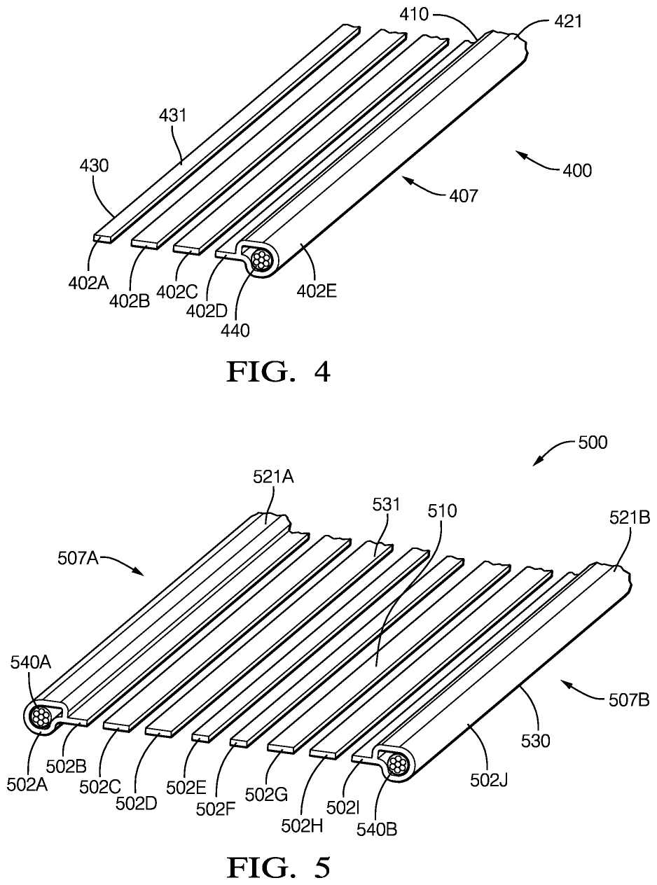

FIG. 4 depicts an example of a wiring cable 400 that includes a plurality of elongate sections 402A-402E that are encased in a common protective jacket 420 with a planar surface 431 that serves as a flat outer surface 410 of the wiring cable 400. As shown in FIG. 4, wiring cable 400 includes elongate sections 402A-402E that each may carry an elongate electrical conductor with a rectangular cross-section, as described above with respect to FIG. 2. According to the example of FIG. 4, a single annular signal conductor 440 is arranged near at an elongate edge 407 of the wiring cable 400, and a section 402E is wrapped around annular signal conductor 440 to form a channel 421 that partially or completely surrounds annular signal conductor 440 to shield annular signal conductor 440 from interference and/or integrate annular signal conductor 440 with wiring cable 400 by securing annular signal conductor 440 in place. Channel 421 is analogous to channel 121 depicted in FIGS. 1A and 1B applied to annular signal conductor 140B, which may be formed by one or more combinations of extrusion, lamination, or other processes as described above.

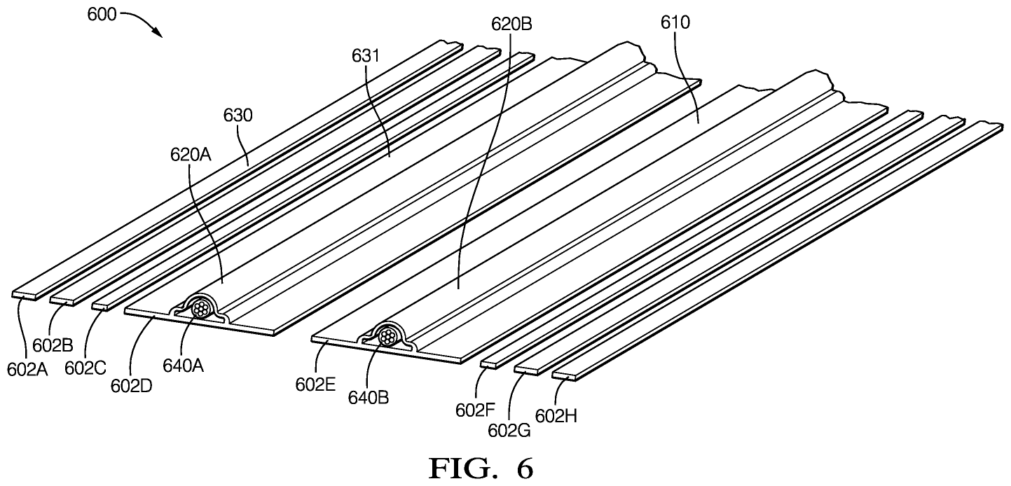

FIG. 5 depicts one example of a wiring cable 500 that includes a plurality of annular signal conductors 540A, 540B integrated with the wiring cable 500 that includes a plurality of sections 502A-502J, at least of some which carry elongate electrical conductors with a rectangular cross section as described above with respect to FIG. 2. As shown in FIG. 5, wiring cable 500 includes a first annular signal conductor 540A arranged in a first channel 521A formed from a first section 502A at a first elongate edge 507A of the wiring cable 500, and a second annular signal conductor 540B arranged in a second channel 521B formed from a second section 502J at a second elongate edge 507B of the wiring cable 500.

According to the example of FIG. 5, annular signal conductors 540A, 540B are arranged near respective elongate edges 507A, 507B of the wiring cable 500. End sections 502A, 502J are wrapped around respective annular signal conductors 540A, 540B to form channels 521A, 521B that partially or completely surrounds annular signal conductors 540A, 540B to shield annular signal conductor 540A, 540B from interference and/or integrate annular signal conductors 540A, 540B with wiring cable 500 by securing annular signal conductors 540A, 540B in place. Channels 521A, 521B are each analogous to channel 121 depicted in FIGS. 1A and 1B applied to annular signal conductor 140B, which may be formed by one or more combinations of extrusion, lamination, or other processes as described above.

FIG. 6 depicts one example of a wiring cable 600 that includes a plurality of annular signal conductors 640A, 640B integrated with the wiring cable 600 that includes a plurality of sections 602A-602H, at least of some of which carry elongate electrical conductors with a rectangular cross-section encased in a common protective jacket 620 with a planar surface 631 as described above with respect to FIG. 2. In some examples, the protective jacket 620 includes a shielding layer 236A, as also described with respect to FIG. 2.

As shown in FIG. 6, wiring cable 600 includes a first annular signal conductor 640A arranged on section 602D, and a second annular signal conductor 640B arranged on section 602E. As shown in FIG. 6, single annular signal conductors 640A, 640B are arranged on surface 610 such that the protective jacket 620 shields at least a portion of the annular signal conductors 640A, 640B. Annular signal conductors 640A, 640B may be high-speed data cables with a dielectric layer as an annular outer surface, for example a coaxial or twisted-pair high-speed data cable without a shielding or a plastic coating. In some examples, annular signal conductors 640A, 640B may be different types of cables. For example, annular signal conductor 640A may be a jacketless coaxial cable, while annular signal conductor 640B may be a jacketless twisted pair cable, or vice versa.

As also shown in FIG. 6, a shielding structures 620A, 620B, which each include a shielding layer 216 as depicted in FIG. 2, are integrated with the wiring cable 600. Shielding structures 620A, 620B are analogous to shielding structure 120 depicted in FIGS. 1A and 1B applied to annular signal conductor 140A, and may be formed by one or more combinations of extrusion, lamination, adhesive tape, or other mechanisms as described above.

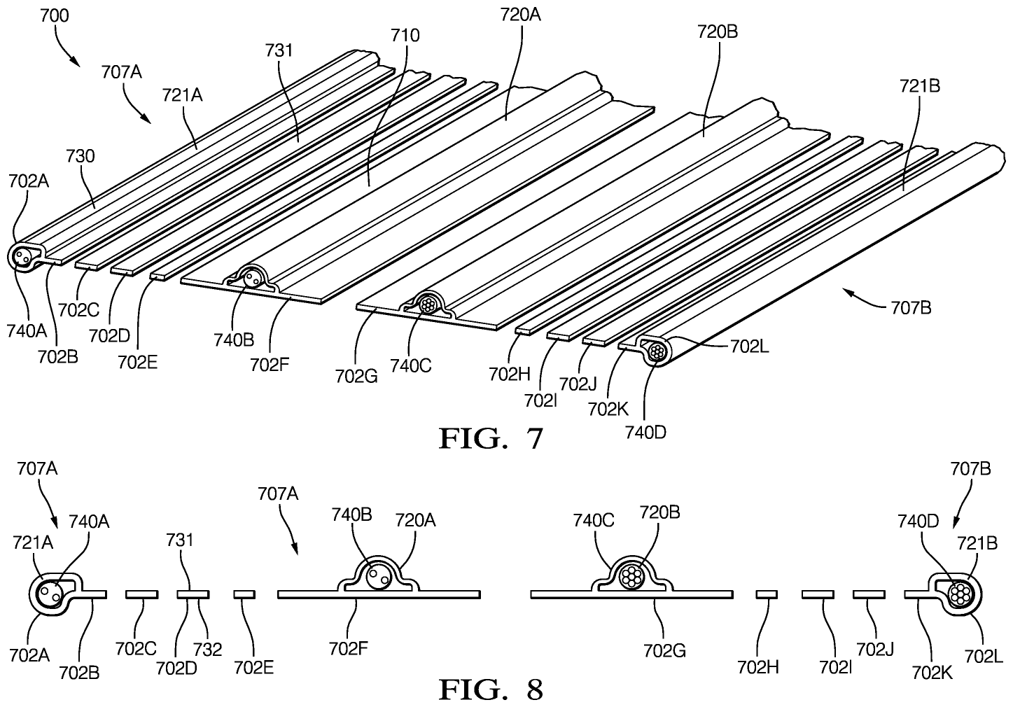

FIG. 7 depicts one example of a wiring cable 700 according to some embodiments. FIG. 8 is a side view of connector 700 according to some embodiments. Wiring cable 700 includes a plurality of annular signal conductors 740A-740D integrated with the wiring cable 700 that includes a plurality of sections 702A-702K, at least some of which carry elongate electrical conductors with a rectangular cross section encased in a common protective jacket 720 with a planar surface 731 as described above with respect to FIG. 2. In some examples, the protective jacket 720 includes a shielding layer 236A, as also described with respect to FIG. 2

As shown in FIG. 7, wiring cable 700 includes annular signal conductor 740A arranged in a first channel 721A formed from a first section 702A at a first elongate edge 707A of the wiring cable 500, and annular signal conductor 740D arranged in a second channel 721B formed from a second section 702K at a second elongate edge 707B of the wiring cable 700.

According to the example of FIG. 7, annular signal conductors 740A, 740D are arranged near respective elongate edges 707A, 707B of the wiring cable 700. End sections 702A, 702L are wrapped around respective annular signal conductors 740A, 740D to form channels 721A, 721B that partially or completely surrounds annular signal conductors 740A, 740D to shield annular signal conductor 740A, 740D from interference and/or integrate annular signal conductors 740A, 740D with wiring cable 500 by securing annular signal conductors 740A, 740D in place. Channels 721A, 721B are each analogous to channel 121 depicted in FIGS. 1A and 1B applied to annular signal conductor 140B, which may be formed by one or more combinations of extrusion, lamination, or other processes as described above.

As shown in FIG. 7, wiring cable 700 further includes annular signal conductors 740B and 740C, which are each arranged on respective sections 702F, 702G of wiring cable 700, and shielded by respective shielding structures 720A, 720B integrated with wiring cable 700. As also shown in FIG. 7, shielding structures 720A, 720B, which each include a shielding layer 216 as depicted in FIG. 2, are integrated with the wiring cable 700. Shielding structures 720A, 720B are analogous to shielding structure 120 depicted in FIGS. 1A and 1B applied to annular signal conductor 140A, and may be formed by one or more combinations of extrusion, lamination, adhesive tape, or other mechanisms as described above.

As described herein, annular signal conductors 740A-740D may be high-speed data cables with a dielectric layer as an annular outer surface, for example a coaxial, twisted-pair, or other high-speed data cable without a shielding or a plastic coating. In some examples, annular signal conductors 740A-740D may be different types of cables. For example, as shown in the example of FIGS. 7 and 8, wiring cable 700 includes two twisted pair annular conductors 740A and 740B, and two coaxial annular signal conductors 740C and 740D, each of which include a central core surrounded by a dielectric layer that defines an outer surface of the annular conductor. In other examples, different combinations of jacketless annular cables may also be used as annular conductors 740A-740D.

The various wiring cables described herein integrate one or more annular signal conductors with a wiring cable, and in doing so, introduces a non-planar shape to the wiring cable. In some examples, the non-planar shape of the respective wiring cables 100, 200, 300, 400, 500, 600, and 700 described herein may be utilized to secure the wiring cables within a vehicle. For example, a track, clip, or other fixation mechanism may include grooves that correspond to an annular features of the respective wiring cables 100, 200, 300, 400, 500, 600, and 700, which may assist with alignment of the wiring cables, as well as reliably securing the wiring cable within a vehicle.

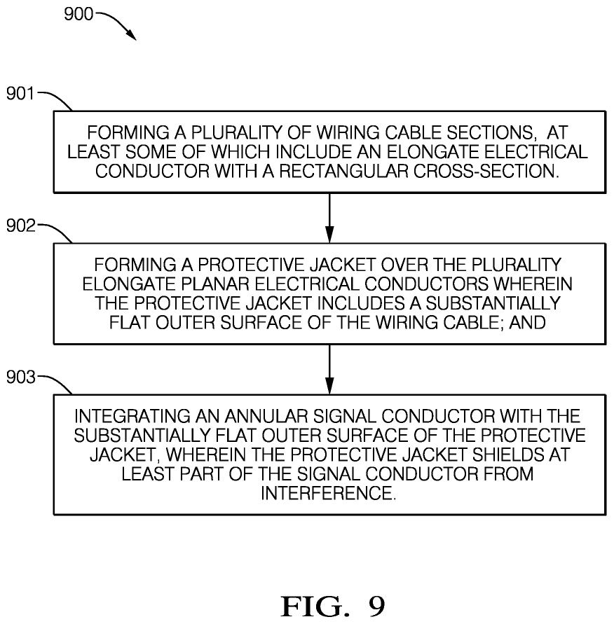

FIG. 9 is a flow diagram that depicts a method 900 of forming a wiring cable according to some embodiments. As shown in FIG. 9, at step 901, the method includes forming a plurality of wiring cable sections (e.g., 102A-102F depicted in FIGS. 1A and 1B) at least some of which include elongate electrical conductors with a rectangular cross-section (e.g., 202A-202D depicted in FIG. 2). The plurality of elongate electrical conductors may each be configured to couple components of an electrical and/or communications systems of a vehicle.

As also shown in FIG. 9, at step 902, the method further includes forming a protective jacket (e.g., 130) over the elongate electrical conductors. The protective jacket includes a substantially flat outer surface (e.g., 110) of the wiring cable. In some examples, the protective jacket includes a shielding layer (e.g., 236A), which may be a metallic mesh or other conductive structure suspended in the protective jacket.

As also shown in FIG. 9, at step 902, the method further includes integrating an annular signal conductor (e.g., 140) with the substantially flat outer surface such that the protective jacket shields at least part of the annular signal conductor from interference. In some examples, the annular signal conductor includes a dielectric layer surrounding a conductive core that presents an outer surface of the annular signal conductor. In some examples, the annular signal conductor may be considered “jacketless” in that it does not include a protective coating, or shielding that surrounds the dielectric layer.

In some examples, integrating the annular signal conductor with the substantially flat outer surface includes arranging the annular signal conductor on the substantially flat outer surface, and arranging a shielding structure (e.g., 120) over the annular signal conductor to shield the annular signal conductor and secure the annular signal conductor to the protective jacket.

In other examples, integrating the annular signal conductor with the substantially flat outer surface includes arranging the annular signal conductor near an elongated edge of the wiring cable, and wrapping a section of the wiring cable around the annular signal conductor to form a channel (e.g., 121) that at least partially surrounds the annular signal conductor and secures the annular signal conductor to the protective jacket.

In some examples, the annular signal conductor is jacketless high-speed signal conductor. In some examples, the annular signal conductor is a jacketless coaxial conductor. In other examples, the annular signal conductor is a jacketless twisted pair conductor. In some examples, integrating the annular signal conductor with the substantially flat outer surface further comprises forming vias through the protective jacket to improve a shielding performance of the wiring cable. As one example, the method includes forming vias through the protective jacket, to couple a shielding layer (e.g., 236A) of the shielding structure to a shielding layer (e.g., 216) of the protective jacket. In other examples, the method includes forming vias through the protective jacket to couple a shielding layer (e.g., 236A) of the protective jacket to itself, to improve a shielding performance of the wiring cable.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A wiring cable, comprising:
a plurality of elongate planar electrical conductors electrically insulated from one another and shielded by a protective jacket formed over the elongate electrical conductors, wherein the protective jacket includes a substantially flat outer surface of the wiring cable; and
a signal conductor with an annular outer profile integrated with the protective jacket at the substantially flat outer surface and at least partially shielded from interference by the protective jacket of the wiring cable.

2. The wiring cable of claim 1, wherein the annular outer profile of the signal conductor comprises an annular outer surface of a dielectric layer that surrounds an annular conductor.

3. The wiring cable of claim 2, wherein the substantially flat outer surface of the wiring cable contacts the annular outer surface of the dielectric layer.

4. The wiring cable of claim 1 wherein the protective jacket wraps around the annular outer profile of the signal conductor at an edge of the wiring cable, and substantially surrounds and shields the signal conductor.

5. The wiring cable of claim 4, wherein the protective jacket includes a shielding layer formed over the plurality of elongate planar electrical conductors.

6. The wiring cable of claim 5, further comprising vias between different sections of the shielding layer brought together by the protective jacket wrapped around the annular outer profile of the signal conductor.

7. The wiring cable of claim 1, wherein a first portion of the annular outer profile of the signal conductor is shielded by the protective jacket, and wherein a second portion of the annular outer profile of the signal conductor is shielded by shielding structure integrated with the protective jacket.

8. The wiring cable of claim 7,
wherein the protective jacket includes a first shielding layer that shields the first portion of the annular outer profile, and wherein the shielding structure includes a second shielding layer that shields the second portion of the signal conductor.

9. The wiring cable of claim 8, further comprising:
at least one via between the second shielding layer and the first shielding layer through the protective jacket.

10. The wiring cable of claim 7, wherein the shielding structure is laminated onto the protective jacket.

11. The wiring cable of claim 7, wherein the shielding structure is extruded onto the protective jacket.

12. The wiring cable of claim 7, wherein shielding structure comprises a tape with an adhesive that secures the shielding structure to the protective jacket and the signal conductor and secures the signal conductor in place.

13. The wiring cable of claim 1, wherein the signal conductor comprises a first signal conductor integrated with the protective jacket at the substantially flat outer surface of the wiring cable, and further comprising a second signal conductor with an annular profile integrated with the protective jacket at the substantially flat outer surface of the wiring cable, and wherein the first signal conductor and the second signal conductor are configured to fit within a track arranged within a vehicle to secure the wiring cable to the vehicle.

14. The wiring cable of claim 1, wherein the signal conductor does not include an annular sheathing layer or an annular plastic layer over an outer surface of the signal conductor.

15. A method of forming a wiring cable, comprising:
forming a plurality of elongate planar electrical conductors electrically insulated from one another;
forming a protective jacket over the plurality elongate planar electrical conductors wherein the protective jacket includes a substantially flat outer surface of the wiring cable; and
integrating a signal conductor with an annular outer profile with the substantially flat outer surface of the protective jacket, wherein the protective jacket at least partially shields the signal conductor from interference.

16. The method of claim 15, wherein the annular outer profile of the signal conductor comprises an annular outer surface of a dielectric layer that surrounds a core conductor.

17. The method of claim 15, wherein integrating the signal conductor with the outer profile of the signal conductor at an edge of the wiring cable to substantially surround and shield the signal conductor.

18. The method of claim 15, wherein integrating the signal conductor with the protective jacket includes shielding a first portion of the signal conductor with a shielding layer of the protective jacket, and shielding a second portion of the signal conductor with a shielding structure integrated with the protective jacket.

19. The method of claim 18, wherein integrating the signal conductor comprises using one or more processing steps selected from the group consisting of:
laminating the shielding structure onto the protective jacket;
extruding the shielding structure onto the protective jacket; and
using an adhesive to adhere the shielding structure to the protective jacket.

20. The method of claim 18, wherein integrating the signal conductor comprises using the same or similar process that was used to form the protective jacket to form the shielding structure.
